(19) United States
(12) Patent Application Publication
(10) Pub. No.: US 2009/0293325 A1
(43) Pub. Date: Dec. 3, 2009

(54) LUGGAGE IDENTIFIER

(76) Inventors: John A. Gebler, Indianapolis, IN (US); Ruth E. Stevens, Indianapolis, IN (US)

Correspondence Address: GLOBAL PATENTS/RANDY W. TUNG, ESQ, 838 W. LONG LAKE, SUITE 120, BLOOMFIELD HILLS, MI, 48302, US

(21) Appl. No.: 12/130,084

(22) Filed: May 30, 2008

(51) Int. Cl. G09F 3/20

(52) U.S. Cl. 40/6

(57) ABSTRACT

A luggage identifier formed by a generally rectangular shaped identifier body formed of leather or plastic that has a substantially transparent cover on a top surface and at least one adhesive strip on a bottom surface, and a cavity formed between the substantially transparent cover and the identifier body for receiving strips of bright colored paper.

### FIELD OF THE INVENTION

The present invention generally relates to a luggage tag and more particularly, relates to a luggage identifier that is equipped with bright colored paper strips to stand out from out luggage.

### BACKGROUND OF THE INVENTION

Luggage is an inevitable part in the life of a traveler. It is used whenever a person travels in the airplane, in a train, in a car, etc. When the luggage of one person is mixed with other luggage of other travelers, such as at an airport, a bus depot, etc., it is important that the person's luggage can be readily recognized so that it does not get mixed up with other people's luggage. This is difficult since most luggage are manufactured by a limited number of luggage suppliers and furthermore, similar styles of luggage are always used by everyone. Instead of tying a pink or purple colored fur ball on the luggage, which can be easily lost during transit, it is desirable to provide a device that can easily identify a specific luggage of a person such that it can be immediately recognized at an airport or a bus depot.

It is therefore an object of the present invention to provide a luggage identifier that identifies a person's luggage easily even when viewed at a distance.

### SUMMARY OF THE INVENTION

The present invention discloses a luggage identifier that enhances the visibility of the luggage and allows it to stand out from other traveler's luggage.

In a preferred embodiment, the present invention luggage identifier can be provided in a generally rectangular shaped identifier body formed of leather or plastic that has a substantially transparent cover on a top surface and at least one adhesive strip on a bottom surface, and a cavity formed between the substantially transparent cover and the identifier body for receiving strips of bright colored paper.

### BRIEF DESCRIPTION OF THE DRAWINGS

The invention will now be described, by way of example, with reference to the accompanying drawings, in which:

FIG. 1 is a perspective view of the present invention luggage identifier.

FIG. 2 is a front view of the present invention luggage identifier.

FIG. 3 is a rear view of the present invention luggage identifier.

FIG. 4 is a cross-sectional view of the present invention luggage identifier.

FIG. 5 illustrates other alternate embodiments of the present invention luggage identifier.

### DETAILED DESCRIPTION OF THE PREFERRED EMBODIMENT

The present invention discloses a luggage identifier that would help to identify a person's luggage apart so that it is readily recognizable even at a distance.

The present invention luggage identifier is a means for travelers to easily identify and locate their luggage. The present invention luggage identifier saves an individual time as well as aggravation when retrieving their luggage in an airport, bus terminal, train station, cruise ship, etc. The luggage identifier consists of a rectangular identification attachment that features a leather casing and a transparent plastic window through which the travel's information is visible. The traveler's name, address, phone number, and destination are displayed in personalized, eye-catching colors, including florescent shades of pink, orange, yellow, green, and purple. The colorful strips are enclosed within the transparent window and can be attached and secured to the handle of the suitcase. The luggage identifier can also be produced in a variety of sizes to accommodate different size luggage.

The appealing features of the present invention luggage identifier are its security, practically, convenience, ease of use, and reasonable price. It provides a means for travelers to easily identify their luggage even from a distance and saves valuable time at an airport, bus or train station. The present invention makes traveling more enjoyable by reducing the time and aggravation associated with retrieving luggage. It also provides individuals with enhanced safety and may deter another traveler from mistakenly taking their luggage. The luggage identifier can be produced in various sizes and styles, and can also be personalized to identify totes and purses. It is also easy to secure, and eye-catching due to the bright colors.

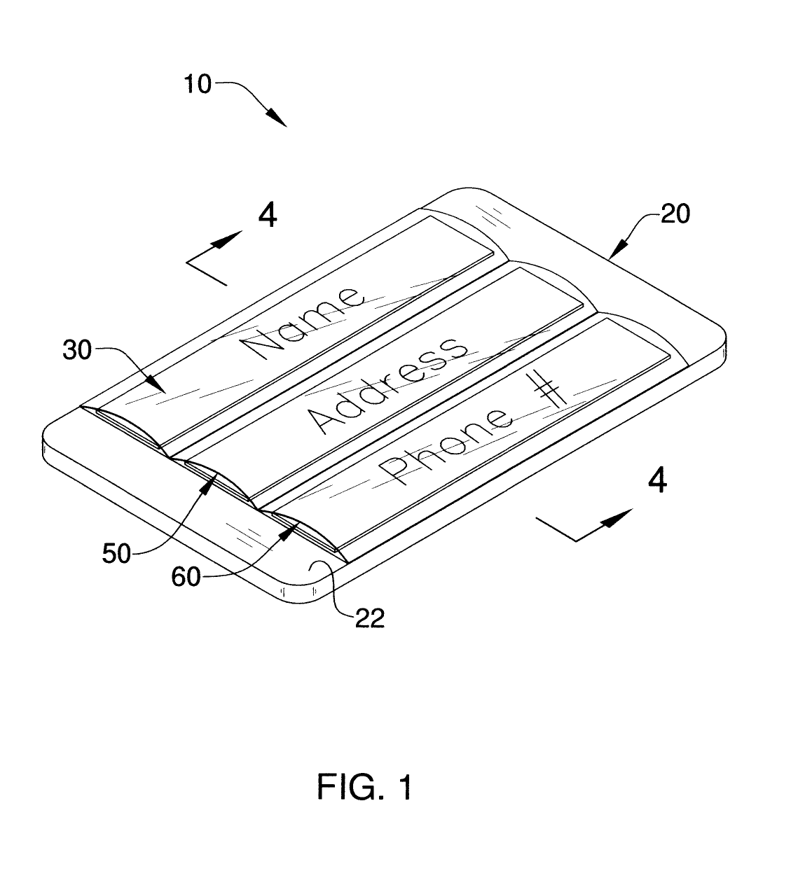

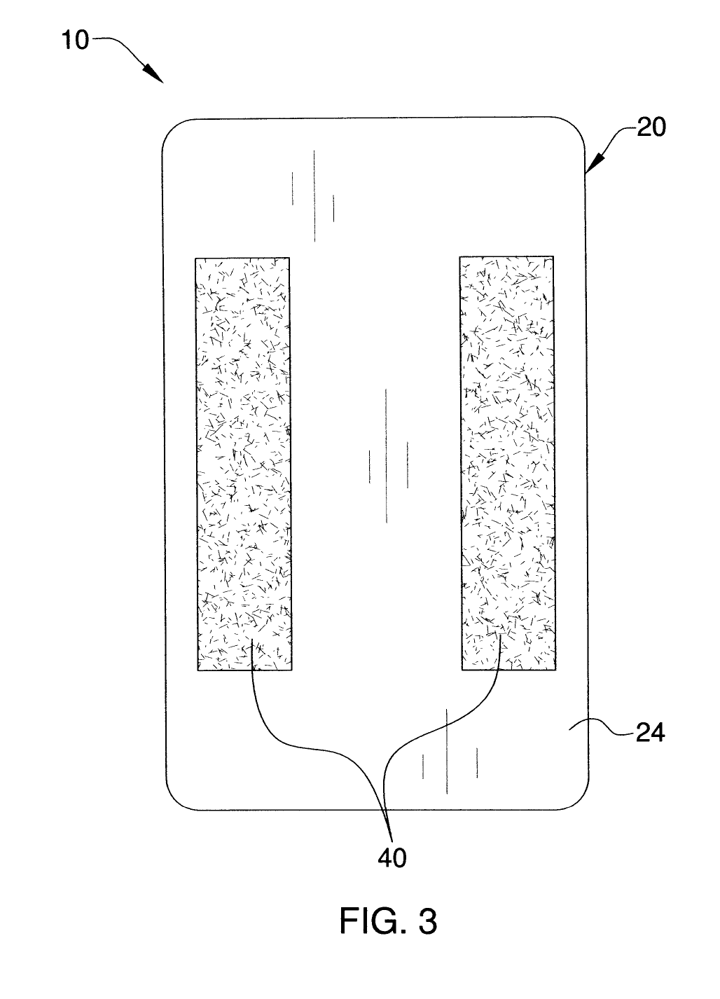

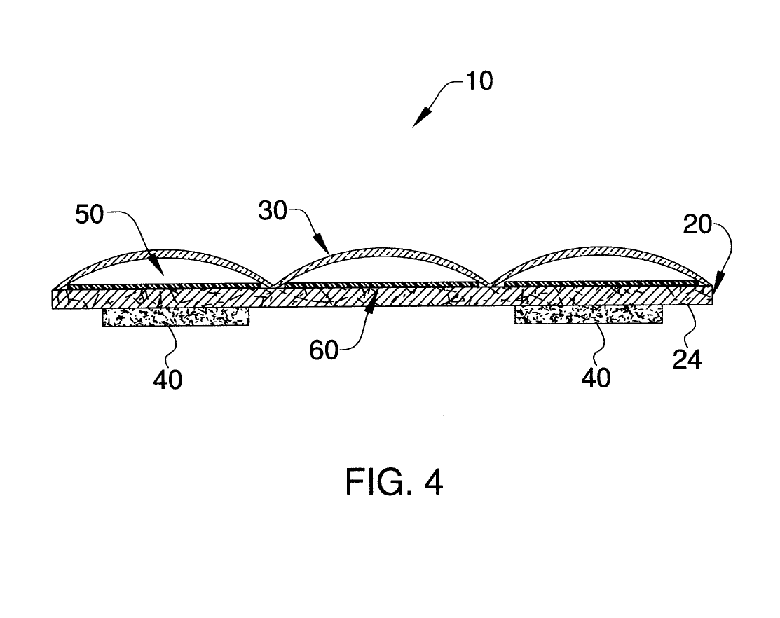

Referring initially to FIG. 1, wherein a present invention luggage identifier 10 is shown in a perspective view. The luggage identifier 10 is constructed of a generally rectangular shaped identifier body 20 formed of leather or plastic. The identifier body 20 has a substantially transparent cover 30 over a top surface 22 and at least one adhesive strip 40, shown in FIGS. 3 and 4 on a bottom surface 24.

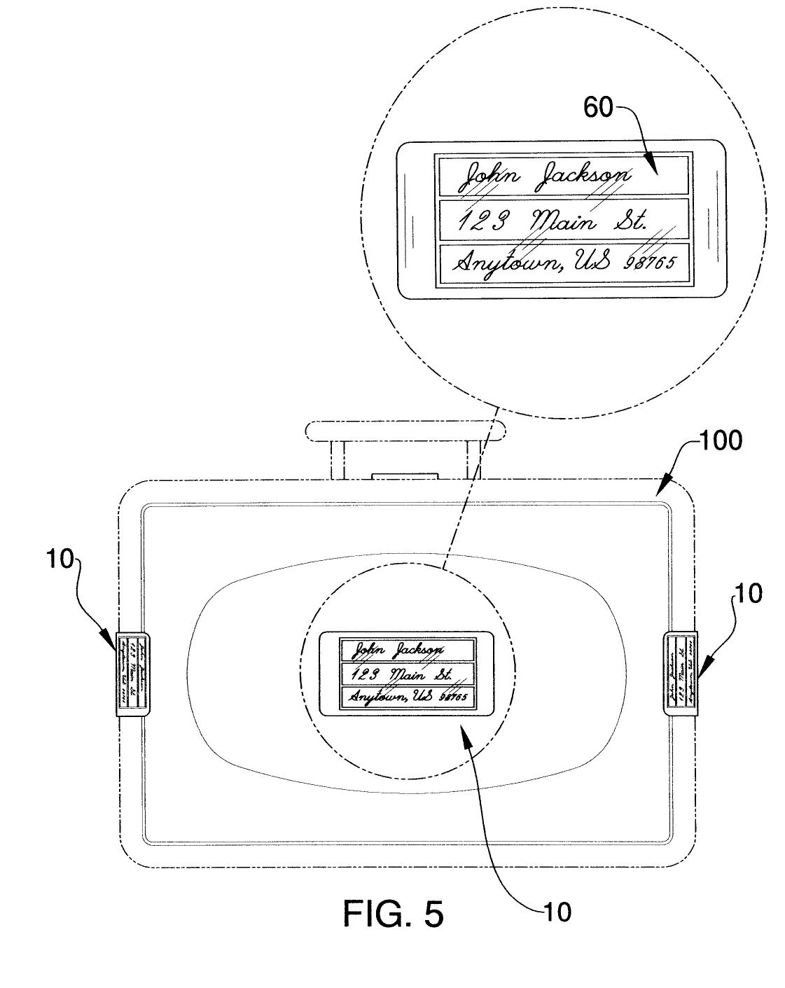

A cavity 50 is formed between the substantially transparent cover 30 and the identifier body 20 for receiving strips of bright colored paper 60. This is shown in FIGS. 1, 4 and 5. The mounting of the present invention luggage identifier 10 on a luggage 100 is shown in FIG. 5. The luggage identifier 10 can be mounted either right in the middle of the luggage 100, or can be mounted, by adhesive layer, on the two ends of the luggage 100, as shown in FIG. 5. The bright colored paper can be suitably formed of fluorescent shades of pink, orange, yellow, green and purple. The colorful strips can be enclosed within the transparent window 30.

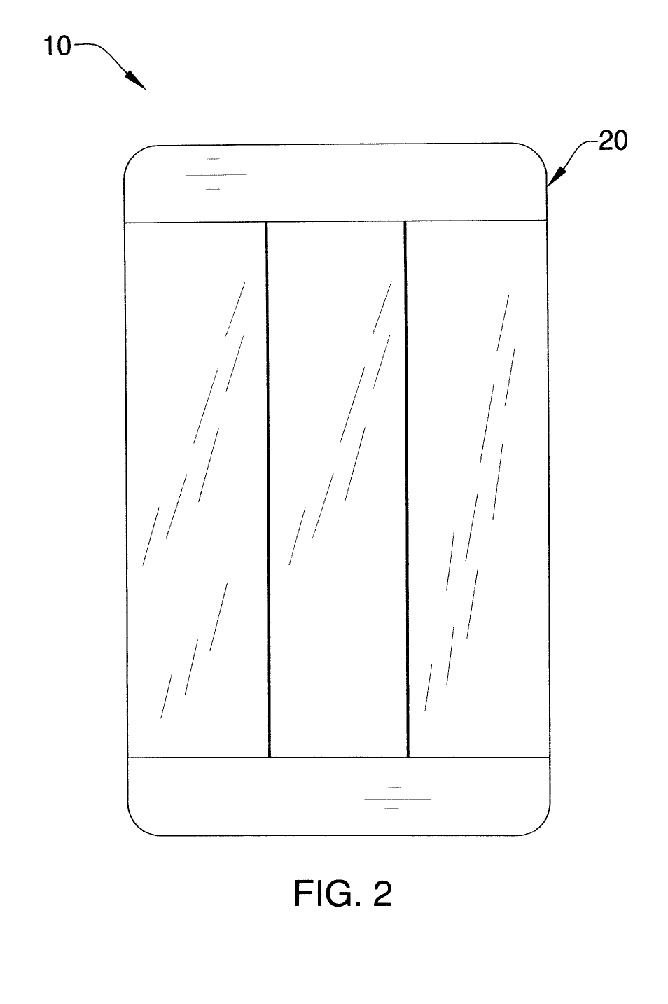

The present invention luggage identifier has therefore been amply described in the above descriptions and in the appended drawings of FIGS. 1-5.

While the preferred embodiments of the invention have been described above, it will be recognized and understood that various modifications can be made in the invention and the appended claims are intended to cover all such modifications which may fall within the spirit and scope of the invention.

1. A luggage identifier comprising:
a generally rectangular shaped identifier body formed of leather or plastic having a substantially transparent cover on a top surface and at least one double-sided adhesive strip which provides removable mounting on a bottom surface; and
a cavity formed between said substantially transparent cover and said bottom surface for receiving strips of bright colored paper.

2. (canceled)

3. The luggage identifier according to claim 1, wherein said substantially transparent cover is formed of Plexiglas.

4. The luggage identifier according to claim 1, wherein said substantially transparent cover is formed of polycarbonate.

5. The luggage identifier according to claim 1, wherein said bright colored paper has a color selected from the group consisting of fluorescent pink, fluorescent orange, fluorescent yellow, fluorescent green and fluorescent purple.
